(19) United States
(12) Patent Application Publication
(10) Pub. No.: US 2009/0023492 A1
(43) Pub. Date: Jan. 22, 2009

(54) Systems and Methods for Enhancing the Gaming Experience

(76) Inventor: Ramin Erfanian, Vancouver (CA)

Correspondence Address: MOAZZAM & ASSOCIATES, LLC, 7601 LEWINSVILLE ROAD, SUITE 304, MCLEAN, VA, 22102, US

(21) Appl. No.: 12/113,932

(22) Filed: May 1, 2008

Related U.S. Application Data
(60) Provisional application No. 60/958,130, filed on Jul. 3, 2007.

(51) Int. Cl. G06F 17/00

(52) U.S. Cl. 463/23; 463/42

(57) ABSTRACT

Devices and methods are disclosed which relate to the collection, analysis, and dissemination of data optionally alongside specific content provided by 3^{rd} parties related to skill-based games in the gaming industry, in particular gambling. Data from users are collected and analyzed against the best practices or special style of playing to discover patterns and other related relationships which can be helpful to the user or gambler.

This application claims priority to U.S. Provisional Patent Application Ser. No. 60/958,130, filed Jul. 3, 2007, the content of which is hereby incorporated by reference in its entirety into this disclosure.

### BACKGROUND OF THE INVENTION

1. Field of the Invention

The present invention relates to data collection, transformation, delivery and use. More particularly, the present invention relates to systems and methods to capture data regarding skill-based gaming, including gambling play, which is used to create useful statistics, knowledge discovery or intelligence feedback, and to educate players, dealers and gaming establishments.

2. Background of the Invention

The popularity of the gaming industry has given rise to numerous new games of skill and chance. For example, one of the oldest and most universal of these games is poker. Poker is a card game with many variants where players bet on their combination of cards, or hand, against others' hands with the winning hand determined by an established hierarchy of hand rankings. Modern tournament play and the emergence of online play have tremendously increased the popularity of the game. Events such as the WORLD SERIES OF POKER can be seen on television with the winner of the event receiving millions of dollars. The popularity of the game has also spread to casinos where players can find an increased number of cash games as well as tournament style of play.

Quite often, a casual player will enter a casino to play a skilled-based game. He buys his chips, sits down, and plays a few hands of the skill-based table game, “tries his luck,” not knowing what awaits him. He knows the basic rules of the game, but beyond that he's relying on his luck. For example, in poker, in the player's fourth hand, the player has a straight draw after the turn (the fourth community card). He sees this as his opportunity to win a hand but the opponent to his right raises an amount equal to half of the total pot value. The player thinks about all the money in the pot and calls, not realizing the odds are against the next community card being the one he needs. The final card comes and it's not the card he wanted, but it gives him a pair. Unfortunately, it is only the third highest card on the board that creates the pair. What does he do now? The opponent to his right only puts forth a small bet. Is the opponent to his right trying to trick him into calling? Did the player to his right miss a straight as well? The player calls and sees his pair lose to a higher pair. Before he knows it his chip stack starts dwindling and soon his chips are gone. The player has no idea where he went wrong. Which hands should he have folded? When should he have raised? These are questions that will plague him and often keep him from playing again or, conversely, turn the player into a “problem gambler.”

In poker, unlike most other casino games, the casino is not a participant in the actual game. The casino simply lets the players compete against each other and then takes a small percentage, or rake, of each hand. Thus, the casino does not have the same incentive to keep players fairly ignorant of what the player is doing wrong. In fact, the casino wants more players playing more hands. However, a player who has lost, and has no idea why he has lost, is less likely to return or play again.

While the rules and play of video poker are generally similar to the live game, there is at least one key distinction. In skill-based video games, like poker, the casino generally has a direct stake in the outcome of each hand. The player either wins or loses each hand by gaining or failing to gain one of a specified list of hands with some opportunity to influence the outcome. If the player wins, the casino pays out the winning amount. If the player loses, the money goes to the casino. While the casino may not seem to have an interest in educating the player, more educated players are willing to play more hands. In the long run, casinos are better off with a higher demand.

Increasing demand has always been a focus of businesses. In recent years, leading companies worldwide have devised novel business models and strategies. Companies such as, for example, Walmart, Costco and Ikea have been working on maximizing customers' profit. Despite the fact that this novel approach appears to lower profit margins, it creates a great deal of recurring business and increases business volume. Similarly, casinos, poker rooms, arcades and gaming parlays would gain tremendously from a more knowledgeable player. They may lose higher profit margins per player as players become more knowledgeable, but a more knowledgeable player is a more satisfied player and a more satisfied player becomes a recurring business for them which in the long run becomes more profitable. The question here is how to make players more knowledgeable which in turn will result in greater demand for gaming.

What is needed in the industry is a system and method that collects player data which it can then interpret, analyze and provide feedback to the player to make the player more knowledgeable about the game and his actions. This in turn makes the game more enjoyable and the player more willing to play again, thus beneficial to both the player and the gaming establishment.

### SUMMARY OF THE INVENTION

The present invention includes devices, systems and methods for collecting, transforming, and delivering skill-based gaming statistics and detailed information to a player. For example, data from hands of poker played by a player are recorded, interpreted based on the game being played, and sent to a centralized server. The data is transformed into relevant poker information and statistics through the use of a logic unit operating consistent with a defined customizable set of rules, which may be called “styles.” The output is delivered to the player either in real time or after a session of playing has finished. The transformation and feedback system would use multiple styles of playing which would open up a great deal of flexibility into how a player would want to be educated, improved or compared with for assessment.

In one exemplary embodiment, the invention is a poker data gathering and statistic and information delivery system. The system includes a collection of data, an interpretation of the collection of data, a server which receives the interpreted collection of data, a logic unit which receives the interpreted collection of data from the server and transforms the collection of data, and a delivery channel which sends a transformed set of data to a user, wherein the collection of data is gathered from hands of a skill-based game played by the user, as well as others.

In another exemplary embodiment, the invention is a method of creating skill-based game statistics and information. The method includes collecting data from a skill-based game, sending the data to a server, processing the data using a logic unit connected to the server in order to create a relevant statistic, and delivering the relevant useful statistic to a user.

### BRIEF DESCRIPTION OF THE DRAWINGS

FIG. 1 shows a system overview, according to an exemplary embodiment of the present invention.

FIG. 2 shows innovations utilizing a system according to an exemplary embodiment of the present invention.

FIG. 3A shows an exemplary embodiment of a method of gathering data inputs.

FIG. 3B shows a system flowchart for data collection, according to an exemplary embodiment of the present invention.

FIG. 4 shows an RFID poker table used to capture data, according to an exemplary embodiment of the present invention.

FIG. 5A shows the initial betting of a hand of Texas Hold 'Em being played on an RFID poker table, according to an exemplary embodiment of the present invention.

FIG. 5B shows the “flop” of a hand of Texas Hold 'Em being played on an RFID poker table, according to an exemplary embodiment of the present invention.

FIG. 5C shows the “turn” of a hand of Texas Hold 'Em being played on an RFID poker table, according to an exemplary embodiment of the present invention.

FIG. 5D shows the “river” of a hand of Texas Hold 'Em being played on an RFID poker table, according to an exemplary embodiment of the present invention.

FIG. 6 shows components of alternative systems, such as video tables, video machines and skilled-based slot machines, according to an exemplary embodiment of the present invention.

FIG. 7A shows delivery channels of a system, according to an exemplary embodiment of the present invention.

FIG. 7B shows a system diagram and flowchart of user feedback and advertisement delivery, according to an exemplary embodiment of the present invention.

FIG. 8 shows third party connectivity, according to an exemplary embodiment of the present invention.

FIG. 9 shows a system diagram and flowchart of how sponsors and third party content sellers would configure. their messages/content and how the information would be delivered, according to an exemplary embodiment of the present invention.

### DETAILED DESCRIPTION OF THE INVENTION

The present invention provides devices, systems and methods for collecting data from one or more players during a game, storing and processing the data into useful statistics and information, then sending short and detailed statistics and information back to the player in an effort to improve the player's skill. The input device collects data regarding the decisions made by a player, including the time it takes the player to make each decision. The data is interpreted by a logic interpretation layer based upon the game being played. The interpreted data is sent to a server where a logic unit in communication with the server transforms the data into useful statistics and information. The original interpreted data and useful statistics are stored in a database in communication with the server. Upon request by a player, the logic unit analyzes that player's data and statistics, and can even present various playing styles, and educates the player by providing playing tips, critiques of play, player patterns and styles, etc. For example, various well known poker players have their own unique styles (e.g., aggressive, passive, reactionary, etc.). Such styles may be pre-programmed into the system to present as a model for players who wish to follow or be compared to that style.

Our feedback subsystem takes all the data about each player's decision and runs it against our best practices Knowledge Discovery Engine (KDE) in order to create meaningful feedback and report cards. As discussed elsewhere, most skilled based games like poker that are influenced by chance and randomness are an inexact science at best. No one decision will be correct at all times. Also, people and decisions that they make are influenced by their style. Each game has certain important parameters or Key Performance Indicators (“KPI”, a term used in the business world for balanced scorecards for defining strategy and management purposes). Under the same circumstances, different players make different decisions based on their style. In order to create a very close representation of what exists out in the real world and within our feedback system, we have defined an engine which would take different decisions under different styles and would create a unique pattern that can be run against any player's data to calculate deviation or congruency. For example in poker, these factors may included in the KPIs: amount of the chips (cash) a player has in front of him; amount of player's bankroll; position he plays on the table relative to the button; raw material or cards, both hole and community; his skills—a major decision influencer; his objective—a major decision influencer; his psychology—a major decision influencer.

Another important factor includes the conditions or possible permutations. One player may go all-in when holding a pair of kings as his hole cards when an Ace is showing on the community cards. Other player may check and yet another player may fold to a minimum raise. The difference in potential actions for a given scenario depends on the “style” of their game.

It is well understood that most players have different styles for different situations/conditions. Therefore, our “KDE style generator” would be able to provide champions, high ranked players and professionals with a wizard driven matrix to capture their style under different values of KPIs and different conditions.

This would allow any skilled-based game player to compare and contrast his style or game data against any of the pre-defined styles in our system. This would create a flexibility needed for our feedback subsystem mapping algorithm so it can generate meaningful report cards and feedbacks for games like poker where different players win consistently with different styles.

In order to further stress the impact of the present technique in evaluating and comparing actions of various players in the gaming industry, one may take another sport, such as tennis, as an example. There have been great tennis champions who have won prestigious tournaments like Wimbledon or the US Open. Players like Ivan Lendel, Mats Wilander and Andre Agassi had baseline styles, and even amongst themselves they had different styles as well. Others like Boris Becker, John McEnroe and Pete Sampras played a serve and volley style which is in complete contrast to baseline but just as effective for winning games. The same concepts are applied to any skilled-based game, according to various embodiments of the present invention.

This comparison of given users' style with a given defined style in turn allows the users to become better players who are likely to play more frequently. Additionally, the system will make that skilled based game world, such as poker, more knowledgeable. By collecting data and creating statistics concerning all aspects of the game, patterns will be discovered, and new theories will be created, perhaps, for example, giving an empirical answer as to which opening hand has the best chance against a pair of aces in a game of Texas Hold 'Em or when it is more profitable to split against dealer's 8 in Black Jack. The knowledge and theories will revolutionize the skilled based gaming world.

A “game,” as used herein and throughout this disclosure, refers to a game that is played by one or more players where one player acts at a time, and the game involves more than pure chance. This refers to a large number of games, most of which can and are played recreationally, but can also be played competitively. Among these games are poker and its many variations, blackjack, roulette, craps, video poker, baccarat, pai gow, solitaire and its variations, hearts, spades, bridge, euchre, cribbage, canasta, gin, rummy, go fish, pinochle, sheepshead, tic-tac-toe, backgammon, BATTLESHIP, checkers, dominoes, go, mahjong and its variations, MONOPOLY, reverse, Othello, RISK, SUDOKU, YAHTZEE, TETRIS, and more. These are typically card or board games, but are not limited to games of that type. Many of the games specifically disclosed herein are already played competitively at casinos, but the disclosure is not limited to games that are actually played in casinos, entertainment parlays, cruise ships, arcades, or public bars.

The system can take or accept data from any table game, video table, coin-operated machine or any other similar device in which some skill by a player creates more probability of winning or improves his/her chance of winning against the computer software, other players, or a combination of the two. The system would then provide a report card, or comprehensive feedback, deliverable based on analysis of his/her actions/decisions during a single or multiple sessions of playing/engagement. “Educational information,” as used herein and throughout this disclosure, refers to any information that a player may find useful. This can range from very basic and well-guided instruction for the novice player to specified raw data and statistics for 3^{rd} parties to highly specialized analysis for the advanced or professional player.

“Useful statistics,” as used herein and throughout this disclosure, refers to a wide variety of statistics useful not only to a player, but to casinos, industry regulators, advertisers, etc. These include, but are not limited to, itemized decisions made, frequency of bets, duration of time needed to make the decisions, outcome of the decisions, effectiveness of the decisions in absolute terms and in comparison to median average, types of bet, amount of bets, bets made in any combination or situation, playing style, relational knowledge and the like.

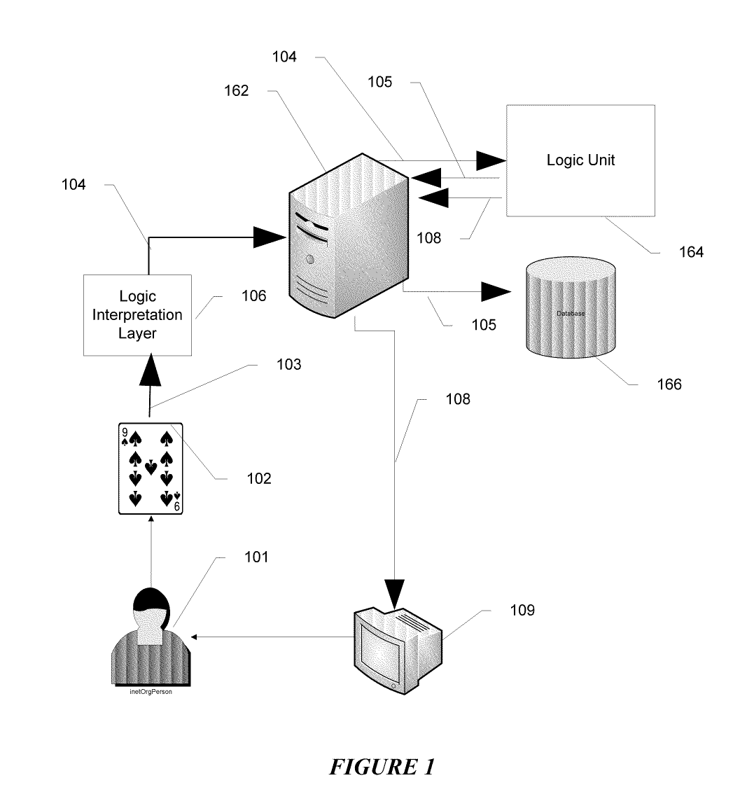

FIG. 1 shows a general overview of an exemplary embodiment of the present invention. In this embodiment, at least one input device 102 gathers raw data 103 from a player 101. This raw data 103 is sent to a logic interpretation layer 106. The logic interpretation layer 106 converts raw data 103 into interpreted data for that specific game 104. This is accomplished by applying the rules of the game being played to raw data 103 and determining the actions that are occurring in the game. For example, in poker, RFID chips may only provide the quantity of chips being moved from one location to another and would have no knowledge of its meaning, e.g., call, raise, etc. Actual interpretation is done by the logic interpretation layer 106. Interpreted data 104 is then sent to a server 162 which is in communication with a logic unit 164 that transforms the data into useful form information and knowledge 105, which may be stored in a database 166. Server 162 then delivers educational information 108 to player 101 through at least one output device 109. Education information 108 may be based on analysis of the data stored in database 166 for a given player 101.

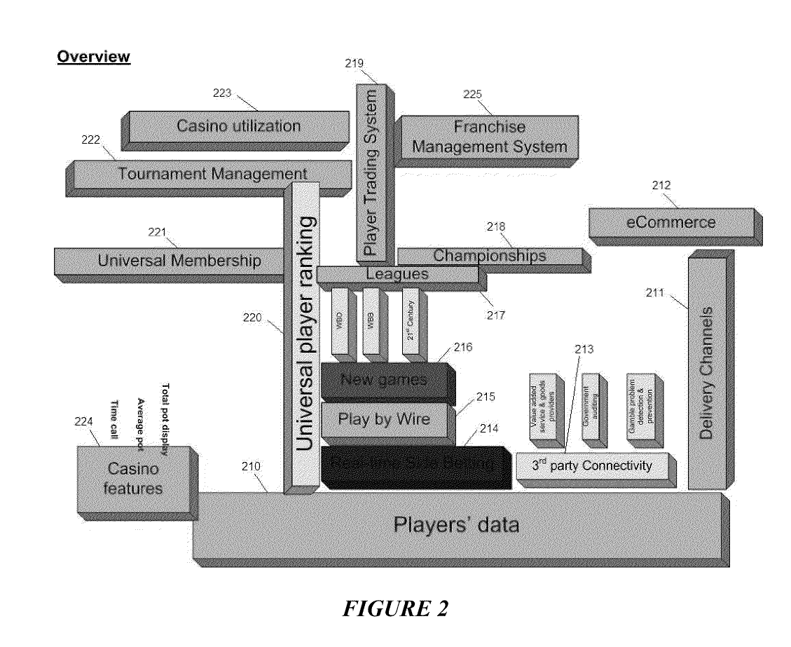

The capturing of poker player data is a base upon which numerous possibilities may build. FIG. 2 shows non-limiting examples of various innovations that may be based upon or utilize the fundamental framework of the present invention. Data is gathered by the system from numerous sources. Specialized poker chips, poker cards, video cameras, monitors, online games, video tables, coin-op machines, and video poker all may feed data through a logic interpretation layer into a central data server 210. The central server 210 utilizes a logic unit which sorts and analyzes the data according to an established set of rules. The output of the logic unit may be sent directly to the player through the server or can be saved into a database for later use and consideration. This output may occur in many different forms and can occur in both real-time or at a future time and date, either pre-programmed or upon request. These each occur through various delivery channels 211. These outputs also provide a method of delivery of electronic commerce 212, such as advertisements. Third party connectivity 213 allows third parties, such as providers of services or the government, to gain access to the saved data by registering with the system and gaining proper authorization. Casinos may utilize the present invention to provide features 224 to players. Among the features 224 which casinos may select are, for example, a display of the pot size, the average pot size, and a time display to determine if a player is taking too long in his play.

The present invention provides a foundation from which countless future innovations spring from and utilize. For example, the system could stand as a platform for real time side betting 214. This would allow a player as well as an outsider to place a bet on any aspect of a hand in progress. For example, two players who have already folded their hands may have an interest in betting on what the winning hand will be. One bets that the winning hand will be a flush while the other bets the winning hand will be a straight. Both players could use a touch screen to enter their bet against each other, with the bet amount being separate from the pot. The winner would receive the amount bet from the other player. An outsider could additionally participate in hands by using a play by wire 215 feature. This allows players anywhere in the world to have a virtual seat at the table, playing in otherwise live tournaments with live players. It would also allow a player to play cash games with casino players from the comfort of his own home.

The present invention also allows a universal player ranking 220 to be created, similar to a “handicap” in golf or player stats in baseball. Player winnings, losses, play time, and many other statistics could be combined to create a ranking system. The system could take into account the skill level of opponents to prevent being skewed by large winnings over greatly inferior players. With this system, players all over the world could be compared based on their play. The rankings could include local rankings, regional rankings, national rankings, and even international rankings. Included in this innovation could be a universal membership 221, with members able to sign up through a website or elsewhere. This membership allows the player to be rated against other members. It also creates the 1^{st} open portal for gaming and casino industry which allows members to advertise and sell their products and services, such as training, consultation, and books, to other members.

Further innovations include new games 216 which could utilize the system. These games could be poker related, card related, or any type of game. The rules of the game could be programmed into a logic interpretation layer and a logic unit in the system which would track the game play and output meaningful statistics and information. These new games, as well as the traditional games, could be the basis for new leagues 217 and championships 218. Leagues would allow players in certain locations or around the world to play against each other. League standings could be calculated and tracked, allowing players to compete against a set of players. These leagues could be comprised of players selecting to compete with each other or could be randomly assigned. Championships could be awarded to the winner of the league or the winner of a league tournament. Along with the league possibility could be teams and franchises. These franchises can be formed with rules which teams within the franchise play under. League standings and divisions could allow team members to track the progress of the team. These teams and franchises could operate under a franchise management system, and recruit and trade players much like professional sports franchises 225.

Casino utilization 223 allows casinos to utilize the system in various ways, including in-tournament management 222 to make tournaments run more efficiently. Because the system knows how many chips each player has and how many players remain at tables, it could calculate the ideal placement for each player and notify the casino. The casino could additionally host its own leagues or franchises for frequent players to join. Some of the features, like display average pot, have been already implemented, but some, like tournament management based on amount of chips, their ranking in a universal ranking system, and skill-set, are exclusive to the disclosures of this application.

FIG. 2 is presented as a general overview of possible innovations which may utilize the present invention. While all of these innovations may use the framework of this disclosure, the present application will be more specifically disclosing the gathering, processing, storing, and delivery of gaming data as well as the channels of delivery and third-party connectivity to the data.

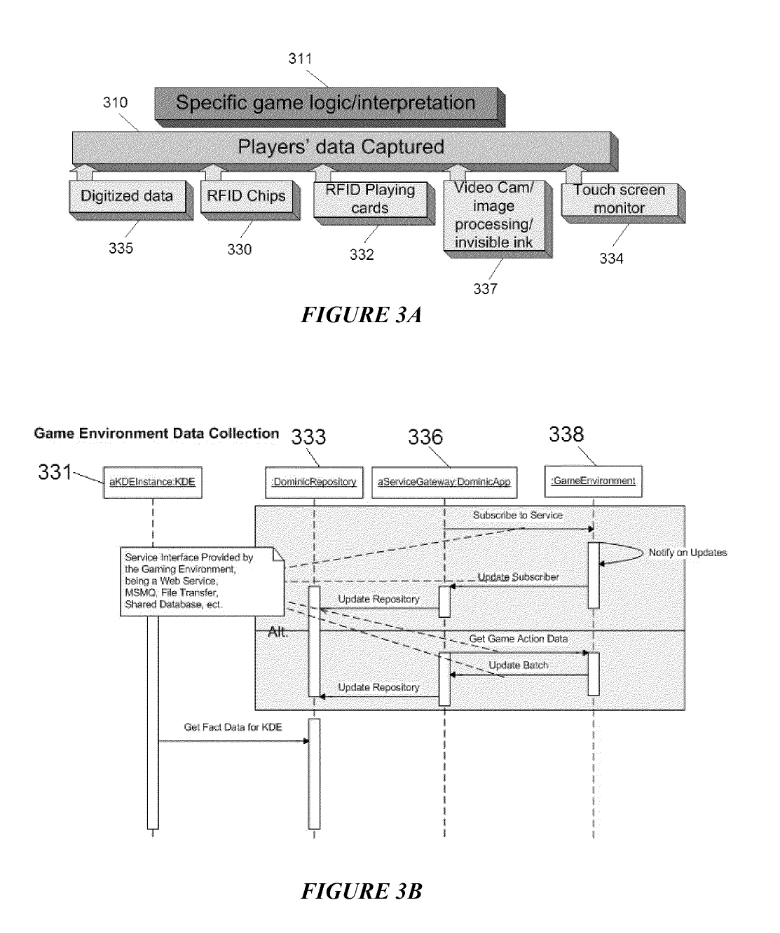

FIG. 3A shows an exemplary embodiment of data input devices for a game of cards comprising RFID chips and playing cards, a kiosk for identification, and at least one RFID scanner. Each player around the poker table is recognized by one of many different methods of identification, such as an issued RFID UUID, a computer generated password which is provided by a customer service desk, a biometric finger print detector, etc. In an embodiment of the invention, the user may input this identification into a touch screen monitor 334. If the player has not previously been entered into the system, he may select to join or be identified solely by the time, date, table number and his position at the table. Once signed in, each player is given playing chips 330. In this embodiment, playing chips 330 include radio-frequency identification (RFID) tags which communicate with one or more RFID scanners in the table. The RFID tags allow the scanners to determine the location of chips, such as in the player's possession or in the pot, and the amount at each location. The scanners detect relocations of playing chips 330 from one location to another, in order to determine data regarding the amount of a bet, which player placed the bet, etc. Playing cards 332 dealt to each player may contain RFID chips as well. RFID playing cards 332 allow the scanners to track each of the players' hands as well as community cards; this would be complementary but an option input. RFID playing cards 332 also allow the scanner to determine whether the player folds and, if so, at exactly what point in the hand. The scanner sends all this information to a logic interpretation layer 311 which it then forwards to a server after appropriate translation. The server provides a logic unit with interpreted data to calculate useful statistics such as betting patterns, patterns in certain positions, etc. In alternate embodiments, such as for online play or video poker, video tables, the player's data can be captured in the form of digitized data 335. In these embodiments, the data is captured by the video poker machine or personal computer.

Alternately, identification may be accomplished using physiological or behavioral biometrics, keycard, or any other method known in the art. Some of these methods may utilize a video camera 337 with image processing or invisible ink technology capture the cards and their state such as in play or mucked. Physiological methods include, but are not limited to, scanning a fingerprint, facial recognition, scanning the iris or retina, and scanning the hand. Behavioral methods include, but are not limited to, voice recognition, keystroke, and signature. The input devices can utilize RFID keys with Universally Unique Identifiers, image recognition, or any other method known in the art to determine the identity of each card and/or the amount of the chips bet and remaining in the player's possession. Many other possibilities for collecting the data will be apparent to one skilled in the art after consideration of the present disclosure.

FIG. 3B shows an exemplary embodiment and flowchart on how data is collected from the physical gaming environment and persisted into the Dominic database 333 for use within the Dominic solution. As used herein and throughout the disclosure, including the drawings, “Dominic” refers to the core technology server and database. As shown in the figure, at least several options are suggested as to how the Dominic solution integrates into the physical gaming environment and interacts with the Knowledge Discovery Engine 331. A first method utilizes a Service Gateway 336, being an interface capable of connecting to disparate applications, using a variety for different integration methods, and using those applications as data sources providing a continuous flow of information from that application. The Service Gateway 336 is aware of the information it needs to consume from the Game Environment 338, the Service Gateway 336 makes a connection to the Game Environment 338 and provides the Game Environment 338 with request information, such as desired content and routing information, in regards to receiving information from the Game Environment 338 as it becomes available. When the Game Environment 338 does have information available based on the request from the Service Gateway 336 an event will fire that will cycle through a recipient list, being a list of subscribers/consumers for request information, and publish information back to the Service Gateway 336, the Service Gateway 336 will in turn update the Dominic database 333 with that information collected from the Game Environment 338.

A second method operates through on-demand via a defined call for information from the business logic unit. The Service Gateway 336 is responsible for sending the request for information to the Game Environment 338 using a variety for different integration methods, the Game Environment 338 responds back to the Service Gateway 336 with the requested results. The integration method varies the integration process, in addition to what is illustrated in the figure, with an additional method involving the Service Gateway 336 to monitor a File System Directory (FSD) for a file, or wait for a FTP request, to be delivered from the Game Environment 338, the Service Gateway 336 would then import the information in from the file into the Dominic database 333.

The Knowledge Discovery engine 331 uses the information collected from the gaming environment as facts, being entities that the rule engine utilizes to create refined analytical data for delivery to a client devise.

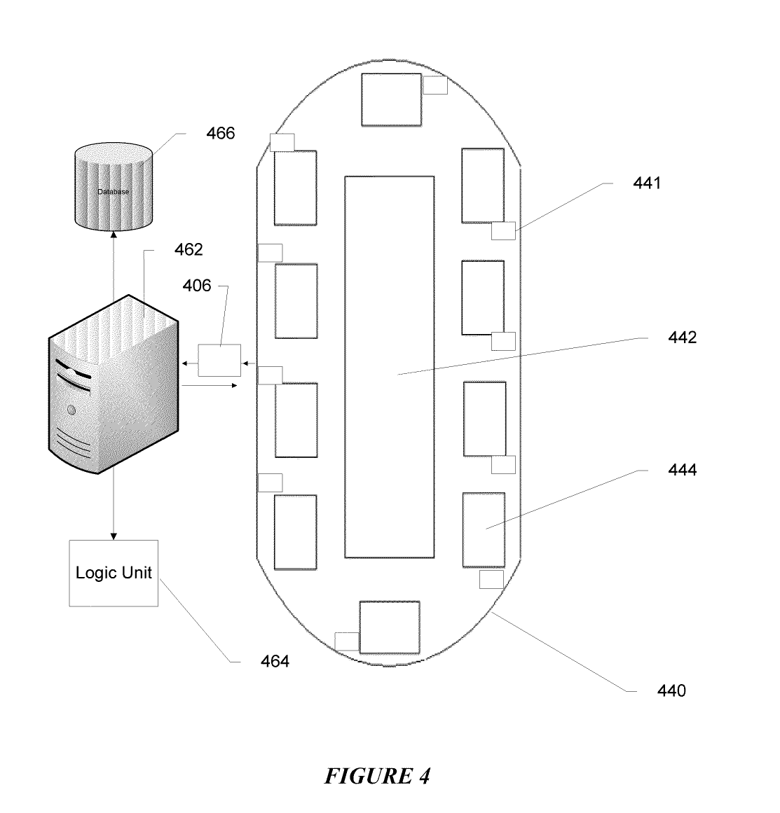

FIG. 4 shows an exemplary embodiment of the present invention featuring all of the elements scaled down in the form of a poker table. In this embodiment, a poker table 440 contains position RFID scanners 444, a community RFID scanner 442, a server 462 having a logic unit 464 and database 466 onboard, a logic interpretation layer 406, RFID playing cards, and RFID chips. The poker table outlines an area in front of each player and a larger area in the center of the table. Each player keeps her cards and chips in the area outlined in front of her. In front of each position at table 440 is position RFID scanner 444. Position scanner 444 detects the RFID chips and RFID cards in the player's outlined area. The center of table 440 contains community RFID scanner 442. Community scanner 442 detects the chips and cards in the center outlined area. Community scanner 442 also detects whether each card is face up or down. RFID scanners 444 at each position and community RFID scanner 442 send raw data to logic interpretation layer 406 including the number of RFID chips in each player's possession, the amount of RFID chips in the pot, the number of cards and identity of cards in a player's hand, the number and identity of community cards, whether cards are face-up or upside down. Logic interpretation layer 406 applies the rules of the game being played to the data to interpret the data.

The server and the database may be at a satellite location (e.g., located in the back office of poker room/casino) and may provide services to more than one table at a time. Server 462 receives the interpreted data from logic interpretation layer 406. Logic unit 464 receives the interpreted data and transforms the data into useful statistics. The interpreted data and useful statistics are stored in database 466. If a player selects on her user interface that she wishes to receive help playing the game, the logic unit analyzes her data and creates educational information. Server 462 sends this educational information back to her user interface where it is displayed. In alternative embodiments, logic unit 464 could additionally perform the actions of logic interpretation layer 406.

In one embodiment, table 440 contains a satellite server which collects the data and sends it to the centralized server through a hard-wire, over the internet, or any other method of sending data. This allows a central server, such as one in a poker room or casino, to gather data from all of the tables. In other embodiments of the present invention, table 440 contains touch screen panels 441. Panels 441 could be used for signing into the system, communicating with the casino, side betting, checking in a hand, and folding cards. Also in other embodiments, panels 441 allow for fingerprint identification or for scanning the retina or iris.

In further embodiments of the table, the table includes video cameras. These video cameras detect movements by the players which can be included in the data sent to the server. A movement recognition program converts the video into data correlating to these movements. Data on the movements can be used to determine the type of player or if a player has a tell.

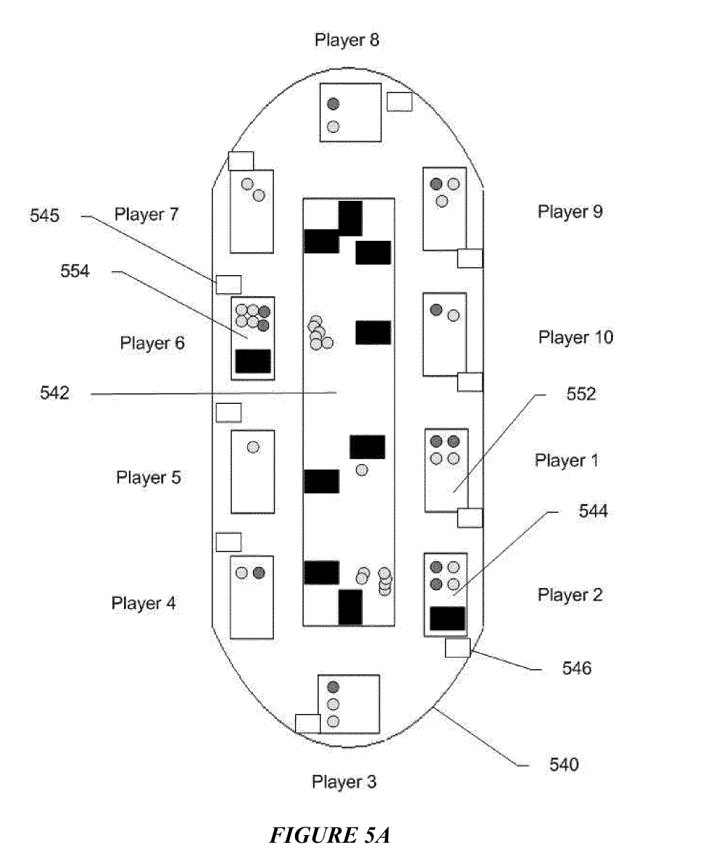

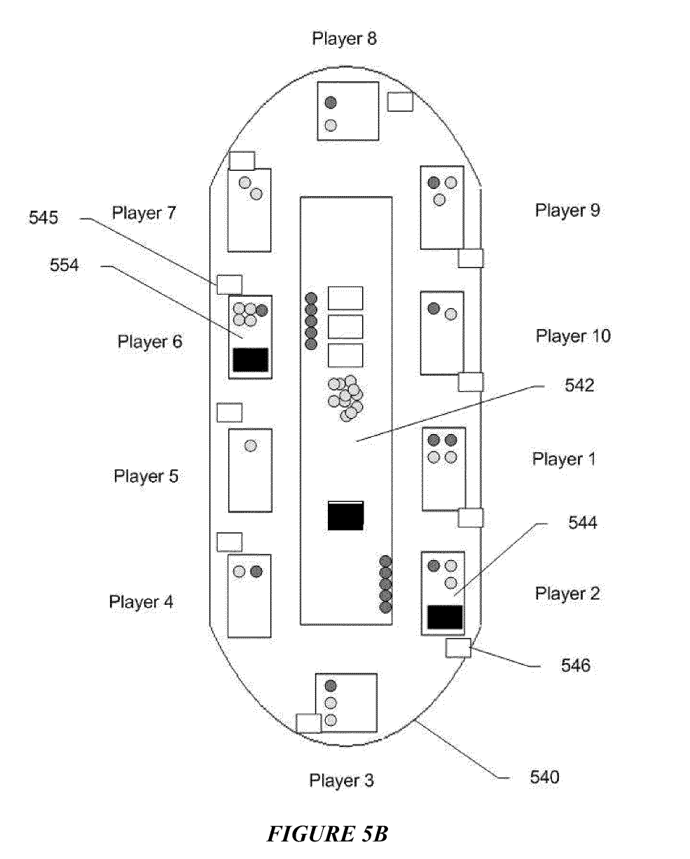

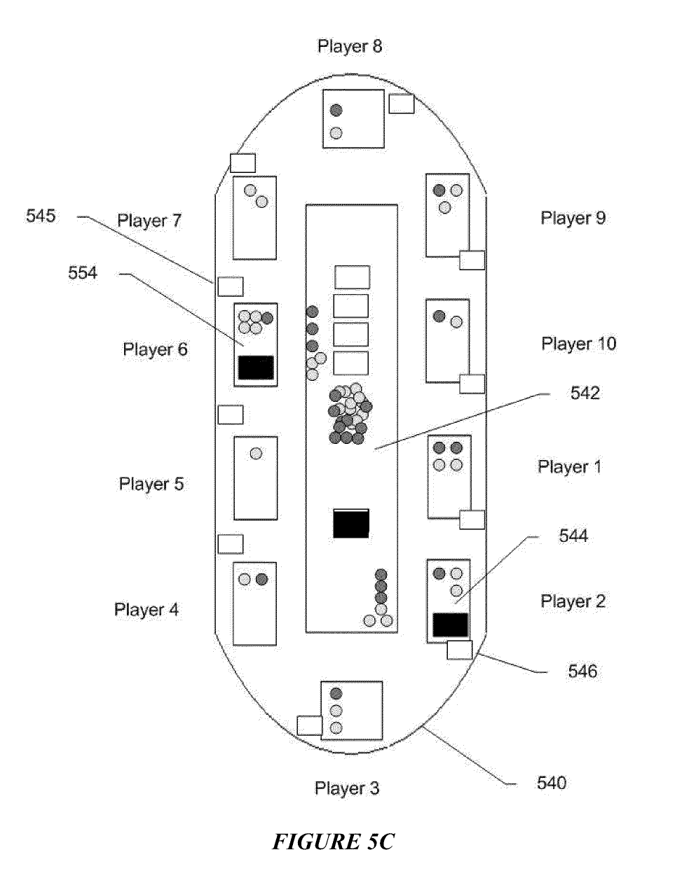

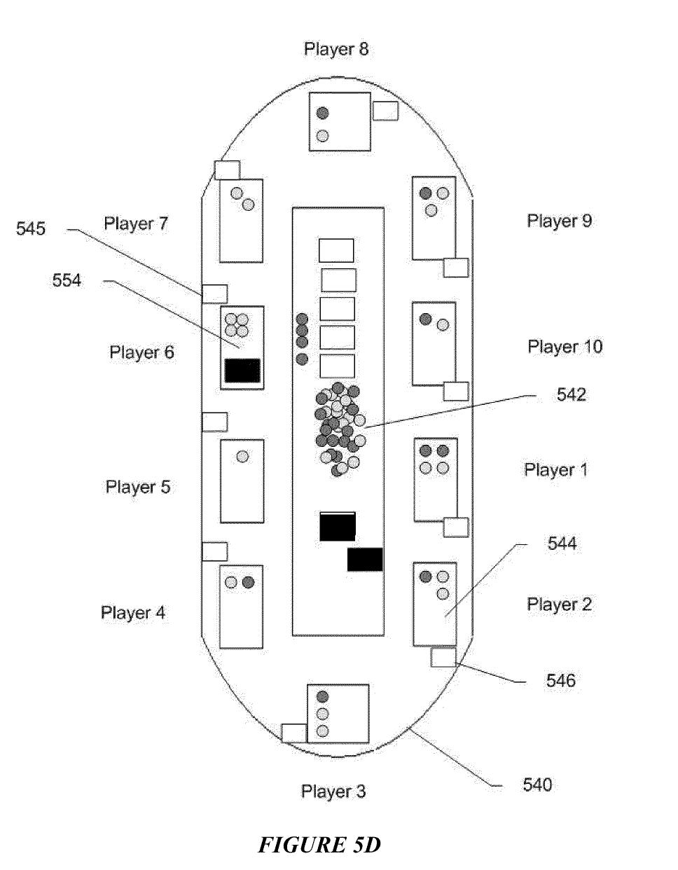

FIGS. 5A-5D show an example hand of Texas Hold 'Em played with the use of data collectors according to an exemplary embodiment of the present invention. In FIG. 5A, each of the ten positions is given two hole cards face down. RFID scanners at each of the positions of the table determine the cards each of the players is holding. RFID scanners also determine the amount of chips each player still has. Player 1 puts $2 in playing chips into the pot as the small blind. Player 2 puts $4 in playing chips into the pot as the big blind. The area in the middle of the table has a community RFID scanner 542 that determines when these RFID chips are moved to the area. A RFID scanner 552 in Player 1's position determines that a $2 chip has been moved from the stack and into the pot. An RFID scanner 544 in Player 2's position determines that a $2 chip has been moved from the stack and into the pot. The betting starts with Player 3, who folds, followed by Players 4 and 5, who each fold. The RFID scanner at each of their table positions determines that their cards have been moved upside down to the middle of the table and thus that they have folded. Alternatively, in the case RFID cards were not used, the logic interpretation layer may deduce a player folded when no change in a player's chip stack was detected where there was one for the next player. The system takes into account what each of these players has done and when, taking into account the amount of chips in the pot, in their possession, the time taken to fold, their position in the hand, etc. Player 6 raises $8 for a total bet of $12. A RFID scanner 554 at Player 6's position determines that $12 leave that position and move to the pot. Community RFID scanner 542 in the middle of the table determines that there is now $18 in the pot. Players 7, 8, 9, and 10 each fold. The RFID scanners at each position or the logic interpretation layer determine that cards are no longer present in those positions and are upside down in the middle of the table. Player 1 also folds from his small blind position. The system takes into account this fold and all of the circumstances occurring at the time. Player 2 decides to call and moves $8 to the pot. The system recognizes the move and determines that it is a call as well as that the total amount in the pot is now $26.

FIG. 5B shows the “flop” and the bets of each player based on these cards. Player 2 checks, which means he does not wish to raise the bet. The system can determine a check in various ways. In an embodiment of the invention, the system determines that Player 2's check has occurred when Player 6 bets $8, because Player 6 is otherwise playing out of turn. Player 6's bet is determined by the system due to the movement of chips from RFID scanner 554 at Player 6's position to the pot within the area of community RFID scanner 542. Player 2 re-raises $12 for a total bet of $20. The logic interpretation layer determines this is a re-raise because it has come after the raise by Player 6 and the amount moved to the pot exceeds the amount necessary to call. Player 6 calls this bet, as determined by the timing of the movement of $12 from Player 6's position to the pot. The system determines that the pot now contains $66.

FIG. 5C shows the “turn” and the bets of each player based on this card. Player 2 bets $15 by moving that amount of chips from his position to the pot. Player 6 calls this amount by moving $15 to the pot as well. The system determines that the pot contains $96 when community RFID scanner 542 recognizes this chip amount.

FIG. 5D shows the “river” card and the bets of each player based on this card. Player 2 checks. Similar to before, the system determines this either by Player 6 playing out of turn or by Player 2 notifying the system. Player 6 raises $60 by moving chips from his position to the pot. Player 2 folds. The system recognizes this because the chips from the pot are moved to Player 6's position. If Player 2 had called, he would have moved $60 into the pot, which the system would recognize. Player 6 would then flip his cards right side up over community RFID scanner 542, which the system would determine. Player 2 could either flip his cards as well or simply put them in the middle of the table upside down, depending on whether or not his hand is higher than Player 6's. The system determines the winner of the hand based on the movement of the chips at the conclusion of the hand. Each of the actions and timings are recognized and recorded as data for the system. Not only are each of these actions recognized by the system, but each player's actions, including betting, time to bet, and amount of bet, is analyzed and stored, to be used as useful statistic in a database which stores historical information about each player's past actions. The instant action or culmination of actions can then be used to determine a player's style or comparison to a known style. Alternatively, live feedback may be provided to each player regarding the player's actions and comparison to his historical and/or given pre-stored style.

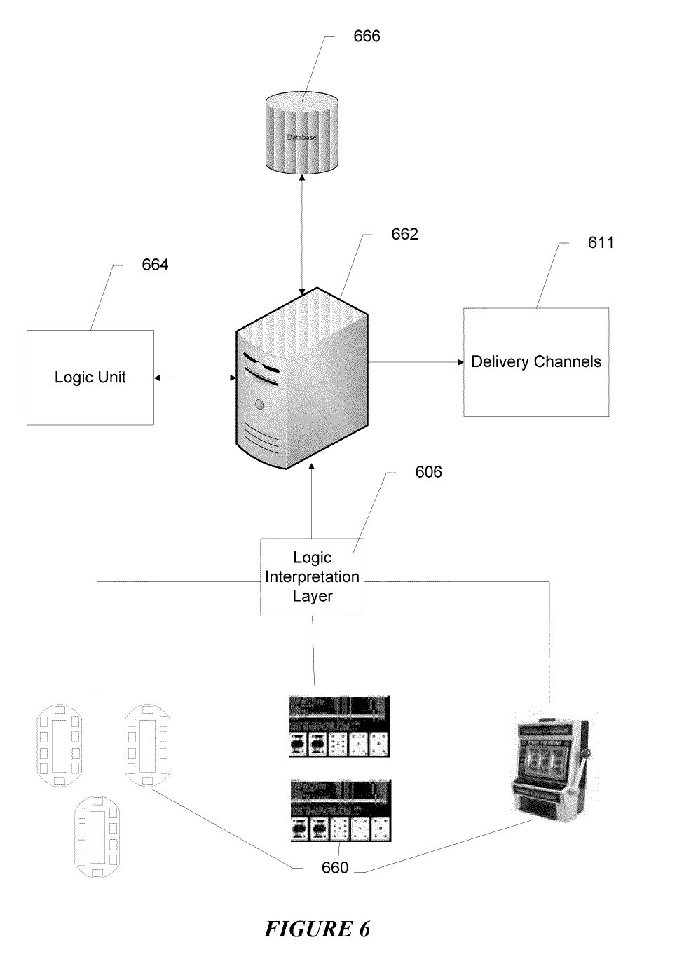

FIG. 6 shows components of a system according to an exemplary embodiment, which may include video tables, video machines and skilled-based slot machines. In this embodiment, the system includes data inputs 660, a logic interpretation layer 606, a server 662, a logic unit 664, a database 666, and delivery channels 611. Collected data from data inputs 660 is received by logic interpretation layer 606. Logic interpretation layer 606 applies the rules of each game being played to the data, creating interpreted data. This interpreted data is sent to satellite server 662. Alternatively, the server may be central, local or specific to each table. Server 662 either sends the interpreted data to logic unit 664 or to database 666 for later use. Data sent to logic unit 664 is transformed into relevant skill-based game statistics. Logic unit 664 transforms data using a specified set of rules. The possible data calculations which can be sent to the players are immeasurable. For example, the game of poker is complex, with multiple positions on the table, various betting amounts, and a variety of types of poker and different hands in each of these types. With the collected data, statistics regarding every decision of the game can be calculated and sent to the players. These statistics range from basic, such as the number or percentage of hands played, to complex, such as average pot size while folding at a certain position after the turn.

For example, in a game of Texas Hold 'Em, data is transformed to show the percentage of hands won while the player is in the “big blind” position. Logic unit 664 sorts the interpreted data such that only data concerning hands while the player is in the big blind is used. Logic unit 664 adds up the number of hands played in that position and the number of hands won in that position. The number of hands won is divided by the number of hands played. The result is the percentage of hands won while in the big blind position. In a real time system, the relevant statistics are sent back to the server which sends the statistics back to the player through a delivery channel. The relevant statistics are also sent to database 666 for later use, e.g., by a universal ranking system.

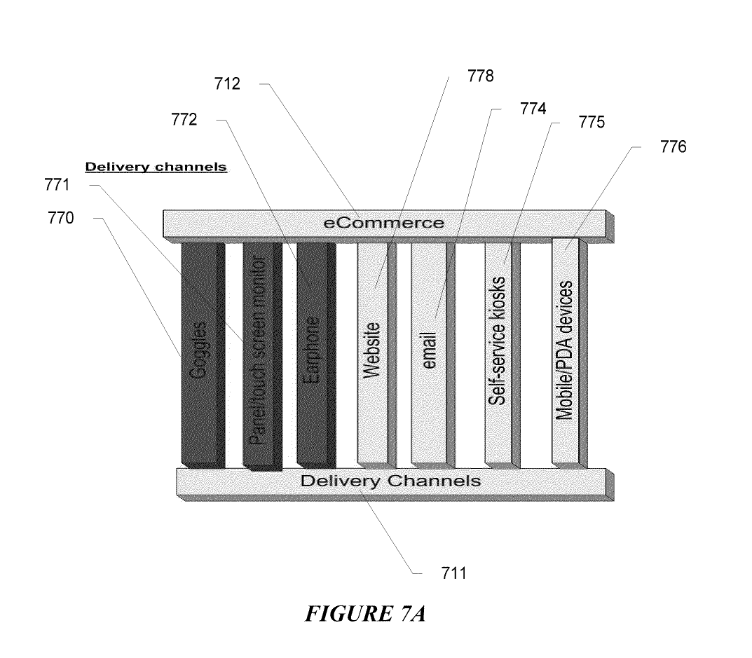

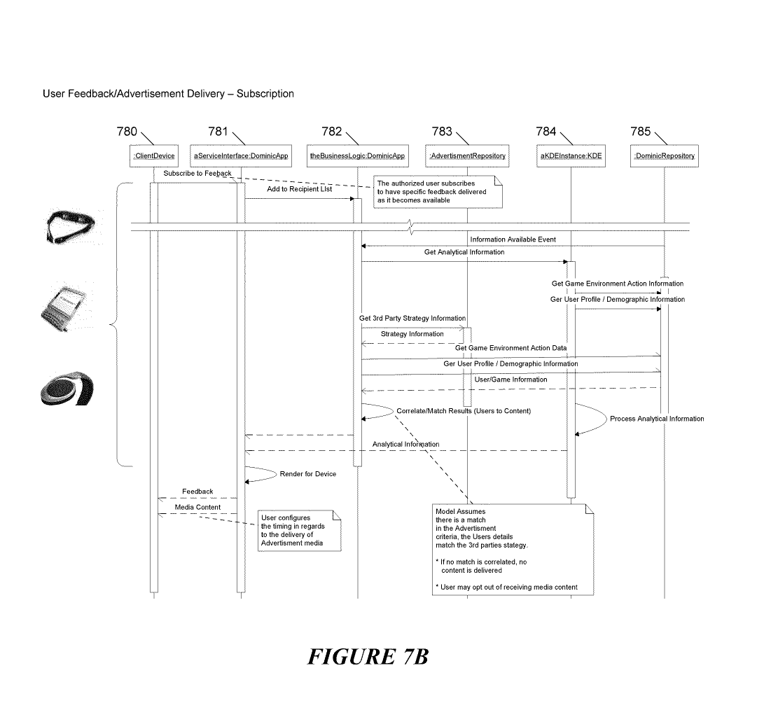

FIG. 7A shows delivery channels 711 for placing useful information into ecommerce 712, such as sending transformed data to players, according to an exemplary embodiment of the invention. These methods include e-mail 774, internet through a website 778, SMS text messaging, a PDA 776, using XML, web services, self-service kiosks 775, earphones 772, goggles 770, panels or touch screen monitors 771, or any other way of delivering data to a user. In this embodiment, the data could be sent to the players either after play is over, after a hand is complete, or even in real-time.

In an exemplary embodiment of the present invention, after the player has finished playing one or more games, he logs into a website 778 to retrieve data concerning his play. Website 778 allows the player to view the results and statistics of his previous poker games. The player can select to see only his stats or those of every position on the table. With appropriate licenses, the player may select to see his statistics against another registered player. These statistics may be fairly basic statistics and include the total amount of time the player has played, the total amount won or lost, the total hands played, the total hands won, the percentage of hands played, the percentage of hands won, the average pot, the average pot won, the average pot lost. The statistics may also be more in depth, such as the percentage of the hands played in each position on the table, the average bet made at each position, the average bet of opponents at the table, the hands associated with each bet by the player and his opponents, or other statistics familiar to one skilled in the art.

In one embodiment, a player can choose against which style of play or player he would want to be analyzed. This would allow different players to choose different playing styles, e.g., in poker one may choose aggressive style of Phil Ivey where another chooses more conservative style of Doyle Brunson.

Additionally, in one embodiment, website 778, thru multiple interaction points, suggests ways to improve the player's game. With the data from the previous games, the system calculates the rate at which the player lost or won chips. The data also contains the cards of each of the player during each of the hands where the wins or losses occurred. This allows the system to determine whether the player is playing too tight and being bluffed out of hands, or too loose and playing hands where the odds are against winning. The system can alert the player of specific hands in which the player called a raise when the odds were not in the player's favor or when the player should have called. The system can explain how the odds are calculated, generally by comparing the number of cards that will help the hand divided by the total number of cards in the deck and the percentage of the pot that the player must call. The system also may alert the player that the player frequently goes on “tilt”. Tilt is when the player, through mental confusion or frustration, knowingly adopts a sub-optimal, over-aggressive strategy. Tilt usually occurs after losses, particularly when a player is the victim of a “bad beat” or suffers a humiliating hand by being bluffed out of a large pot. This may be determined by strings of losses in a row, multiple hands played in a row when the hand is not optimal, calling large raises with a weak hand, betting a large amount of chips after a large loss, etc. With a real time system, the system can alert the player while the tilt is occurring so that the player can alter his play.

From the data, the system may be able to determine, and alert the player, if the player has a tell. A tell is a detectable change in a player's behavior or demeanor that gives clues to that player's assessment of his hand. A tell gives an advantage to a player's opponents by giving them an idea how powerful the player's hand is. If a player consistently bets an amount when bluffing or with a good hand, this may be a tell to the opponents. Additionally, with further data inputs, the system can determine the player's demeanor during bluffs or powerful hands. For example, the player's hands may shake, the player may make forceful gestures during betting, or the player may lean back in his chair. These each could be tells that the player is unaware of which the system could alert him to. Any of this data, in whole or in part, is not limited to delivery through a website and could be sent through any of the other delivery channels as well.

In another embodiment, a player may select to receive auditory data regarding his playing statistics through an earphone 772. In this embodiment, prior to the start of play, the player chooses the data he would like to receive as well as the frequency at which he will receive it. At these specified times, the system will send the selected data to the player's earphone 772. For example, the player may choose to receive data regarding the number of hands he has played and the number of hands he has won after every five hands. The system will collect data on each hand played, calculate the desired data, and send a signal to the player's earphone 772 after every fifth hand. In another embodiment, the user can request data be sent to his earphone 772, making the request from the table while playing. This is accomplished using a device such as a panel on the table or a touch screen monitor. The data the player selects in this embodiment could also or alternatively be sent to the player's cell phone in the form of a text or voice message. In a further embodiment, a provided touch screen 771 could display the data. In another embodiment of the present invention, data concerning play is sent to a player's goggles 770. In this embodiment, part of or all of goggles 770 displays the data in front of the eyes of the player. The display could be projected onto the lens or be embedded in the lens. This could occur in the corner of goggles 770 so as not to block the player's view.

Each of the methods of delivery allow for a unique form of electronic commerce 712 to be sent directly to the player. For instance, with respect to goggles 770, advertisements could be placed around the data sent to the player. This could be a constant advertisement, a rotating advertisement, scrolling advertisement, or other forms known to one skilled in the art.

FIG. 7B shows an exemplary embodiment and flowchart on how user feedback or advertisement may be delivered in real time. As shown in the figure, a client device with the ability to connect and communicate with the Dominic solution 780 accesses a pre-defined service interface in order to access the solutions business/workflow information 781. Client devices 780 may include, but are not limited to, goggles, screen/monitors, earphones or the like. Such access may be provided via publish/subscribe services, being services that allow the client to pre-subscribe to the solution for information as it becomes available. The client device 780 may also be pre-programmed, or alternatively, the service may be pre-set up, to deliver media content in various forms or via various timing or delivery rules. The service interface 781 represents publicly exposed connections into Dominic's business and workflow information. These connections are available to any Dominic approved remote consumer, or provider, or application server. The application server will then use that connection to interact with the business logic unit 782, which works with the service interface 781 to take input requests from the client device 780 and provide the device, via the service interface 781, with the correct results that have been processed through its business rules contained within the business Logic unit 782. The business logic unit 782 may interact with a number of different databases to get various types of information to and from the client device 780. For example, the logic unit 782 may interact with an advertisement database 783 to deliver various advertisements to the client device 780. Such examples could be an advertisement that is targeted specifically for the client device 780 depending on how the client device is pre-programmed or the type of activities that the client device 780 is subscribing to receive content to. The logic unit 782 may also interact with a controller unit 784 that accepts information as input and aggregates that information into knowledge data that is then delivered instantly to the client regarding how a client using a client device 780 should act in a given game. Such information may be intimately related to the gaming database 785 which stores a wealth of information relating to odds, gaming habits, risk assessment and strategies related to any variety of different games that a client device 780 may access. The controller unit 784 and the gaming database 785 work in conjunction to assess an ongoing game that may be occurring, with participants interacting via a user device 780, and the delivery of vital information enabling that user to determine strategies, next moves, etc.

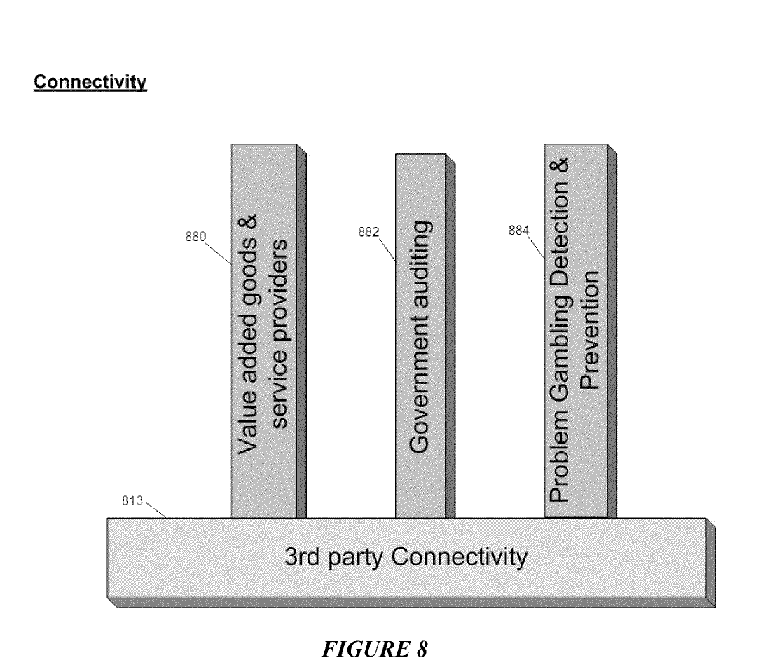

FIG. 8 shows an exemplary embodiment of the present invention which allows for third-party connectivity 813 to the data. In this embodiment, once the data and statistics are stored in the central server, authorized third parties could connect to the data. These parties include value added service and goods providers 880, the government 882, and problem gambling detection and prevention assistance 884. The data provided to these third parties may be in the form of bulk data where the individual players remain anonymous, or, with the consent of players, data on each individual player. Access to the system is granted to those entities that have registered and hold the appropriate credentials for authentication. A second level of credentials may be required to access the records of individual players. This second level of credentials is issued by the individual player to the third party.

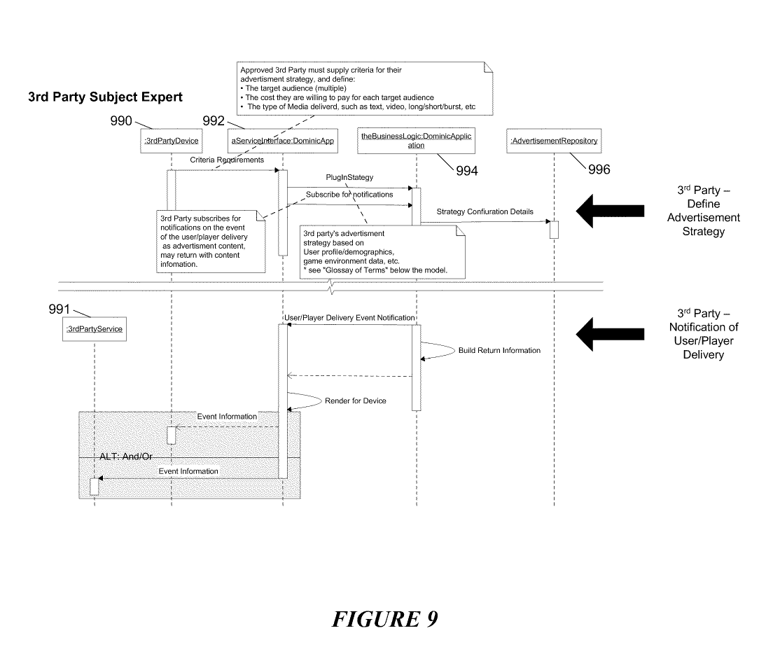

FIG. 9 shows an exemplary embodiment of a system and flowchart showing how sponsors and third party content sellers would configure their messages/content and how the information would be delivered. In a similar fashion as described with respect to FIG. 7B, a third party device 990, being any device that has the ability to connect to the Dominic application via a defined connection, accesses a service interface 992 through secure/pre-approved connection. The interface 990 represents publicly exposed connections into Dominic's business and workflow information. Such third party providers may be previously screened and/or filtered to determine which would be most suitable to use with the present system. Such third parties may have third party services 991 that they intend to promote to users via advertisements through the present system. The 3^{rd} Party services 991 represent a certain business strategy, based on an algorithm along with associated helper components, developed by an outside 3^{rd} party that when aggregated with proprietary data, being information collected from the gaming environment and specific user profile/demographic information, will deliver either a information based or commerce able end result to the client device. Once a third party device 990 accesses the systems through the service interface 992, it may present, alter or cancel its advertisement strategy through a business logic unit 994. This business logic unit 994 stores all information relating to the logistics and means and matter of presenting an advertisement, to whom and how often. Such strategy should be pre-determined by the third party and approved by the system administrator before allowing access to the system and allowing the 3^{rd} party to plug in their strategy.

Further, the business logic unit 994 is utilized, via the service interface 992, to receive configuration details from the client device 990, such configuration details, as illustrated in the bottom half of FIG. 7B, promote the use of client receive notifications on when content is delivered to the defined user base set up within the strategy, when the delivery is sent to the user client device a event is used to trap the processing 994, allowing the strategy to send a notification or allow further processing of the snap in strategy. Further, the business logic unit 994 is associated to the actual advertisement strategies that are pre-stored by the third party and stored within the advertisement database 996. Through the process shown in this figure, targeted advertisements may be delivered to the right users at the right time and frequency.

In one embodiment of the invention, a player allows a third-party to access his private data by providing permissions through secure channels. These secure channels can include a password protected website, mobile based challenge-response, or any other applicable technology. For example, a player may allow third parties to view his statistics in the hope of gaining sponsorship. The player uses a website to select that he wishes his statistics and name to be shared with selected third parties or select types of third parties. These selected third parties may then enter their name and password into the website, access the player's name and statistics, and offer endorsements or special deals to the player.

In a further embodiment, a third party can access mass data without the information that could link the data to a specific player. In this embodiment, the data is in its highest granularity so that it would only be used for statistical or research-oriented activities. Because this embodiment does not identify specific players, it is not necessary for each individual player to first consent, though this could be a condition of using the system. For example, an economist may wish to gain data concerning the fluctuations in the number of poker players at certain times of the year. The economist registers with the website and can then access the mass data which may be further broken down into the desired dates.

In another embodiment, governments or licensed auditors could access financial information of each individual. This would depend on whether the government entity or auditor has the legal right or has been approved by the player. This embodiment could be used by tax lawyers, in financial disputes, or any other relevant area.

Embodiments of the present invention could be used in conjunction with online poker. In these embodiments, the data from each online hand is sent to a server. The server sends the data to a logic unit which sorts and analyzes the data according to a set of rules. The logic unit returns the results to the server which may then send the results to a player or to a database for storage and later use. The logic unit could also send the results directly to a database connected to the server. Alternatively, the data from each online hand is sent to a server which sends it to a database. A logic unit retrieves the data from the database and sorts and analyzes the data according to a set of rules.

Players may access the data and statistics similar to previously described embodiments. In a real time system, the data concerning play is sent to the player while he is still playing. This may allow the player to alter his style of play to improve his results. In another embodiment, the player can view his data after he has finished his online play. Similar to the live system, the player can retrieve data concerning his overall play as well as play during individual hands.

Embodiments of the invention could additionally be utilized in conjunction with video tables, video machines, and coin-op machines. This style of play is generally different from live play, in that the player usually plays his hand trying to gain one of a set list of winning hands. Similar to other embodiments, the player signs into the system. The data from each of the hands played by the player is sent to a server. The server sends the data to a logic unit. This logic unit sorts and analyzes the data according to a set of rules. The results are sent to a database or back to the server which can send the results to the player or to the database. The statistics returned to the player will be similar to those of the live multiplayer games in some respects, but would be based on only the player's hand

For example, a traditional video poker game is 5 Card Stud. In this game, the player inserts money and is given five cards. The user selects which of these cards he wishes to hold and presses a button. The cards not selected to be held are exchanged for other cards to be combined with the held cards for a five card hand. If this hand meets the required criteria, the player wins and receives money back from the machine. The invented system tracks each of the player's hands and sends this data to the central server.

After playing, or during play with a real time system, the player can view his statistics and other data. This may include sets of cards the player held that resulted in winning, percentage of wins with certain hold cards, and other relevant data and statistics familiar to those with skill in the art.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A skill-based game statistic gathering and delivery system, comprising:
a collection of data;
an interpretation of the collection of data based on a specific game being played;
a server which receives the interpretation of the collection of data;
a logic unit which receives the interpretation of the collection of data from the server and transforms the interpretation of the collection of data; and
a delivery channel which sends a transformed set of data to a user in the form of useful information which the player can then use for the game;
wherein the collection of data is gathered from hands of skilled based gamed played by the user, as well as others.

2. The system in claim 1, wherein the collection of data is gathered by using RFID playing chips and an RFID scanning at any given skilled based tables.

3. The system in claim 2, wherein the RFID scanning table has an RFID scanner at each position of the table.

4. The system of claim 3, wherein the RFID scanning table has an RFID scanner at the center portion of the table.

5. The system in claim 4, wherein the collection of data is gathered by using the RFID scanning table in conjunction with RFID playing cards.

6. The system of claim 1, wherein the collection of data is gathered using video and image recognition or invisible ink.

7. The system of claim 1, further comprising a database in communication with the server.

8. The system of claim 7, wherein a third party can access the database.

9. The system of claim 8, wherein the third party is a service or goods provider.

10. The system of claim 8, wherein the third party is the government.

11. The system of claim 1, wherein the delivery channel is one or more of:
e-mail;
a website;
SMS text messaging;
a personal digital assistant (PDA);
XML;
web services;
a self-service kiosk;
earphones;
goggles with a screen projected on a lens; and
a touch screen monitor.

12. The system of claim 1, wherein the hands of skilled based game are played live.

13. The system of claim 1, wherein the hands of skilled based game are played on a video machine or video table.

14. The system of claim 1, wherein the hands of skilled based game are played online.

15. A method of creating skilled based game statistics, the method comprising:
collecting data from a skilled based game;
sending the data to a server;
processing the data using a logic unit connected to the server in order to create a relevant statistic; and
delivering the relevant statistic to a user.

16. The method of claim 15, further comprising storing the data in a database.

17. The method of claim 15, wherein a third party can connect to the database.

18. The method of claim 17, wherein the third party is a service provider.

19. The method of claim 15, wherein the data is collected from live skilled based games.

20. The method of claim 15, wherein the data is collected from video machine games.

21. The method of claim 15, wherein the data is collected from internet skilled based games.

22. The method of claim 15, wherein the data is collected using RFID playing chips and an RFID scanning table.

23. The method of claim 22, wherein the RFID scanning table has an RFID scanner at each position of the table.

24. The method of claim 23, wherein the RFID scanning table has an RFID scanner at the center portion of the table.

25. The method of claim 24, wherein the collection of data is gathered by using RFID playing cards in conjunction with the RFID scanning table.

26. A method of delivering targeted messages to a player during a game, the method comprising:
collecting data from a player during the game;
sending the data to a server;
processing the data using a logic unit connected to the server in order to create a relevant statistic;
searching a relevant message database for messages that pertain to the game; and
delivering the relevant message to the user.

27. The method of claim 26, wherein the relevant message is an advertisement.
